(19) United States
(12) Patent Application Publication
(10) Pub. No.: US 2015/0234081 A1
(43) Pub. Date: Aug. 20, 2015

(54) METHOD OF ASSIGNING GEOPHYSICAL REFERENCE VALUES TO A WELL TRAJECTORY

(71) Applicant: Magnetic Variation Services LLC, Boulder, CO (US)

(72) Inventors: Stefan Maus, Boulder, CO (US); Ryan Croke, Denver, CO (US)

(73) Assignee: Magnetic Variation Services LLC, Boulder, CO (US)

(21) Appl. No.: 14/181,664

(22) Filed: Feb. 15, 2014

(51) Int. Cl. G01V 3/40; G01V 3/38; G01V 99/00

(52) U.S. Cl. CPC G01V 3/40; G01V 99/005; G01V 3/38

(57) ABSTRACT

A method of assigning geophysical reference values to a well trajectory includes defining a set of geophysical reference parameters and assigning a range threshold to each geophysical reference parameter. A Geomodel is processed to determine values of the geophysical reference parameters at a plurality of locations along the well trajectory. The well trajectory is partitioned into a plurality of segments such that variations in the values of the geophysical reference parameters within each segment do not exceed the respective range thresholds. A representative value of each geophysical reference parameter is calculated for each segment and stored or displayed along with the segments.

### FIELD

This disclosure relates to the field of geophysical survey. More particularly, the disclosure relates to a method of generating geophysical reference values for a well trajectory from geophysical survey data.

### BACKGROUND

In geosteering a well towards a known underground target by measurement-while-drilling (MWD), the Earth's geomagnetic field is used as a natural reference. The MWD tool makes a measurement of the magnetic field vector, which is then compared with geomagnetic reference field values to compute the geodetic azimuth of the bottom hole assembly (BHA). The direction and strength of the geomagnetic reference field change along the well trajectory. The most accurate azimuths would therefore be obtained if the exact geomagnetic reference field value was used for every MWD measurement (“survey”) location along the well. Using a different geomagnetic reference field value for every survey location along the well is impractical. On the other hand, using only a single reference value for the entire well results in unnecessary inaccuracies.

### SUMMARY

The subject matter disclosed herein relates to a method of assigning geophysical reference values to a well trajectory, typically for the purpose of geosteering a well.

In one illustrative embodiment, the method includes defining a set of geophysical reference parameters and assigning a range threshold to each geophysical reference parameter to be applied over a select measured depth range of the well trajectory. A Geomodel is processed to determine values of the geophysical reference parameters at a plurality of locations in the select measured depth range of the well trajectory. The method includes partitioning the well trajectory in the select measured range into a plurality of segments such that variations in the values of the geophysical reference parameters within each segment do not exceed the respective range thresholds. A representative value of each geophysical reference parameter is calculated for each segment. The method includes at least one of storing and displaying the segments with the corresponding representative values of the geophysical reference parameters.

In one embodiment, the method further includes adjusting measured depth ranges of the segments prior to calculating the representative values of the geographical parameters for each segment and storing the segments.

It is to be understood that both the foregoing general description and the following detailed description are exemplary of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 shows elements of a geomagnetic field vector in a geodetic reference frame.

FIG. 2A shows a method of assigning geomagnetic reference field values to a well trajectory according to one embodiment.

FIG. 2B shows coordinates of a point on a well trajectory.

FIG. 3 is a flowchart of a well partitioning process according to one embodiment.

FIG. 4A shows a partitioned well trajectory in an area with small geomagnetic field gradients.

FIG. 4B shows a partitioned well trajectory in an area with large geomagnetic field gradients.

FIG. 5A is a block diagram of a computer system embodying a method of assigning geomagnetic reference field values to a well trajectory according to one embodiment.

FIG. 5B shows the display of FIG. 5A with input windows.

### DETAILED DESCRIPTION

A method of assigning geophysical reference values to a well trajectory involves automatically partitioning the well trajectory into segments using a Geomodel, followed by assigning a set of geophysical reference values to each segment. Geologic modeling or Geomodeling is the applied science of creating computerized representations of portions of the Earth's crust based on geophysical and geological observations made on and below the Earth's surface. A Geomodel is the numerical equivalent of a three-dimensional geological map complemented by a description of physical quantities in the domain of interest.

For illustration purposes, the method will be described with a 3D geomagnetic reference field model, i.e., a mathematical description of the Earth's main magnetic field and its annual rate of change, as an example of a Geomodel. However, the method could be used with other types of Geomodels. The method can be applied to an entire well trajectory or just a section of a well trajectory. Where the method is applied to a section of the well trajectory, the method can be repeated for the other sections of the well. The well trajectory may describe a path of a well (or well section) that is yet to be drilled, a path of an existing well (or well section) that is to be re-surveyed, or a path of a well (or well section) where the raw MWD data are being reprocessed with a more accurate geomagnetic model.

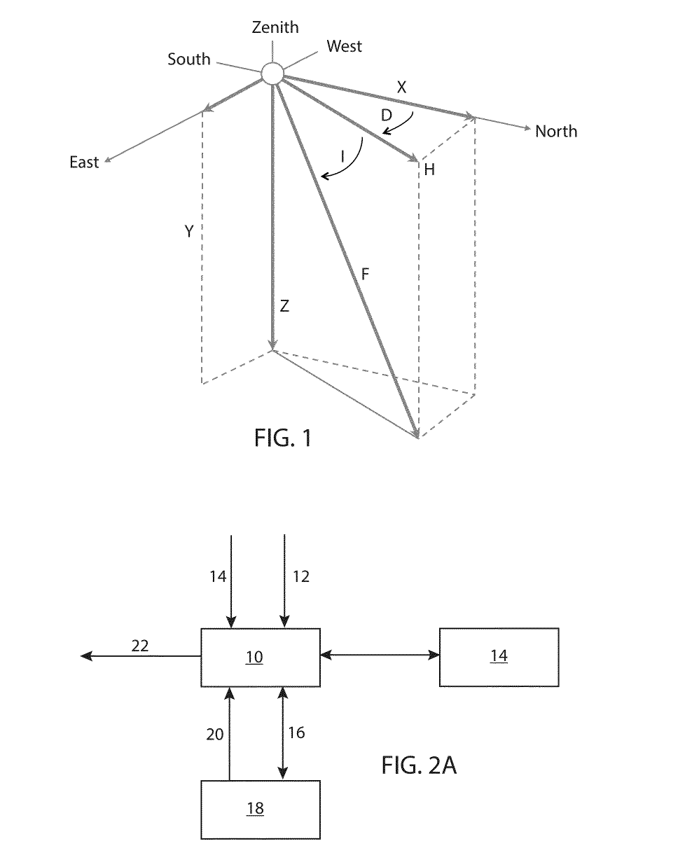

A geomagnetic reference field model describes the natural (Earth's) geomagnetic field. Three magnetic elements are needed to specify the strength and direction of the geomagnetic field vector B. FIG. 1 shows the elements of the geomagnetic field vector B in the geodetic reference frame. The elements are explained below:
X: northerly intensity
Y: easterly intensity
Z: vertical intensity (positive downwards)
H: horizontal intensity
F: total intensity
I: dip (angle, in degrees, measured from the horizontal plane to the field vector, positive downwards)
D: declination (difference, in degrees, measured clockwise from true north to the horizontal component of the field vector)

In directional drilling, the three geomagnetic reference field parameters commonly used are total magnetic field strength (“Btotal”), magnetic field inclination (“Dip”), and magnetic field declination (“Dec”).

For practical purposes, the natural geomagnetic field can be divided into three contributions:
1. The geomagnetic main field, usually given by global main-field models. This contribution primarily originates in the Earth's core and changes slowly on time scales of months to years.
2. The local crustal anomaly or crustal bias, caused by magnetic materials in the Earth's crust.
3. The magnetic disturbance field, caused by electric currents in near-Earth space, and by corresponding mirror-currents induced in the Earth and oceans. The disturbance field typically varies on time scales of seconds to days.

The geomagnetic reference field used for well partitioning represents the sum of the first two contributions, namely the main field (evaluated for a “model date” close to the drilling date) and the crustal field. Since the third contribution varies rapidly and is not known in advance, it will usually not be included in the reference field used for well partitioning.

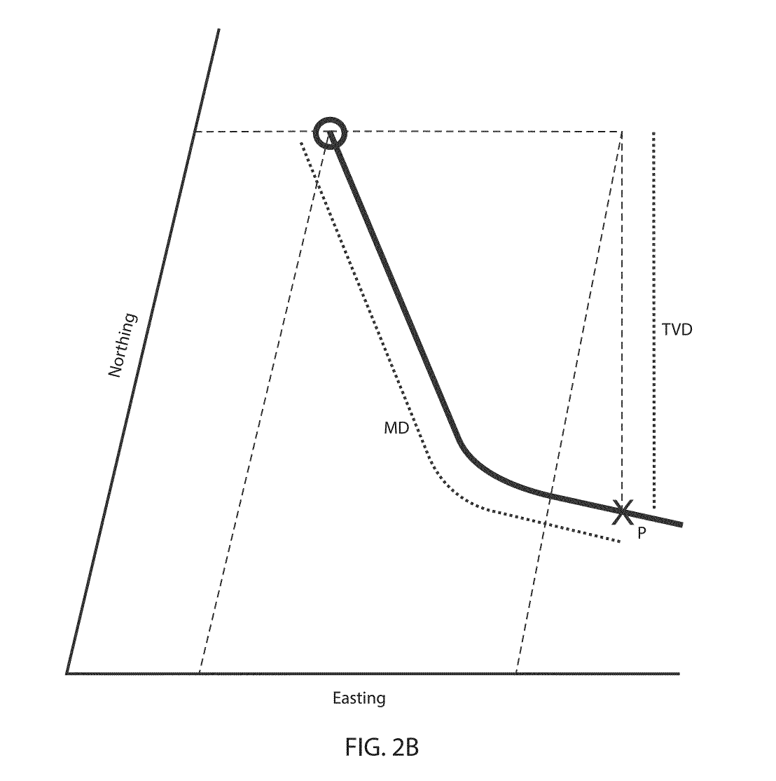

FIG. 2A generally depicts one illustrative embodiment of a method for automatically partitioning a well trajectory into segments. A computer program 10 receives (12) and stores a description of the well trajectory and the survey date. The well trajectory may be described as a series of successive locations or as a geometric construct, e.g., a set of lines and curves or a continuous curve, from which a series of successive locations may be extracted. Referring to FIG. 2B, each location P on the well trajectory has a measured depth (MD, along-the-hole distance), true vertical depth (TVD, vertical distance from the surface), easting, and northing. For each location along the well trajectory, the computer program 10 queries a 3D geomagnetic reference field (GRF) model 14 for the values of a set of GRF parameters for the survey date. In one embodiment, the set of GRF parameters include Btotal, Dip, and Dec. The GRF values are stored along with their respective locations (“well trajectory GRF data”).

In one embodiment, the well trajectory is partitioned such that the variations in the GRF values within each segment do not exceed given range thresholds. The computer program 10 receives (14) and stores the range thresholds to apply to the partitioning of the segments. The range thresholds may be specified by company policy or the tool code that is being used to compute ellipses of uncertainty for the well position. For illustration purposes only, the range threshold for Btotal may be 50 nT, which means that the difference between the maximum and minimum Btotal over each segment should not exceed 50 nT; the range threshold for Dip may be 0.1°, which means that the difference between the maximum and minimum Dip over each segment should not exceed 0.1°; the range threshold for Dec may be 0.1°, which means that the difference between the maximum and minimum Dec over each segment should not exceed 0.1°. Other values besides those mentioned above may be used for the range thresholds.

The range thresholds are specified for a selected measured depth range of the well trajectory. A measured depth range is a range of measured depths between two points on a well trajectory. (FIG. 2B shows a definition of measured depth (MD) for a location P on a well trajectory.) The selected measured depth range may correspond to the entire measured depth range of the well trajectory (i.e., the entire range between the endpoints of the well trajectory) or a fraction of the entire measured depth range of the well trajectory. The latter will usually be the case when the well trajectory is being partitioned in sections. Where the well trajectory will be partitioned in sections, the range thresholds may be specified per section of the well trajectory, where the section will be identified by its measured depth range.

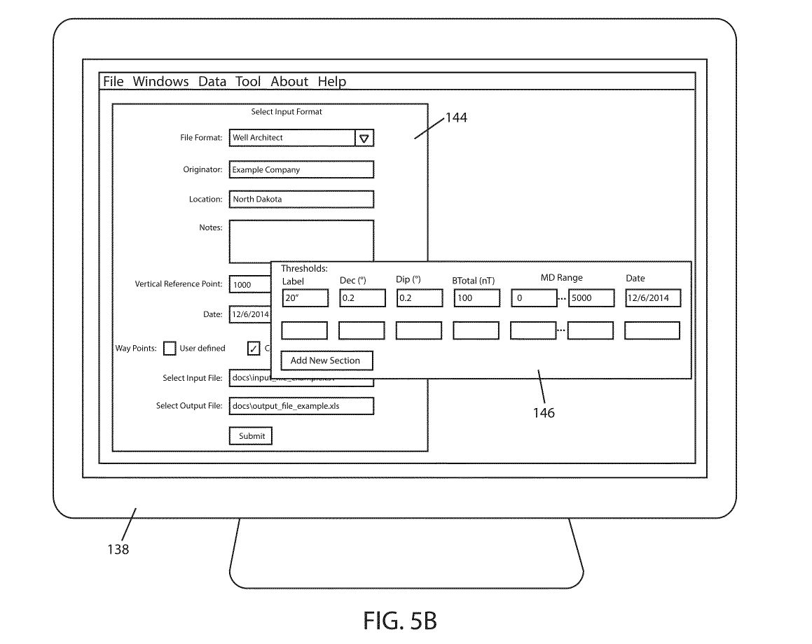

A user can import the description of the well trajectory and the 3D geomagnetic model into a memory of a computer that is configured to run the computer program 10. The user can also define the range thresholds on the computer, e.g., when prompted by the computer program 10 or as one of the inputs to the computer program 10 (e.g., as shown in FIG. 5B).

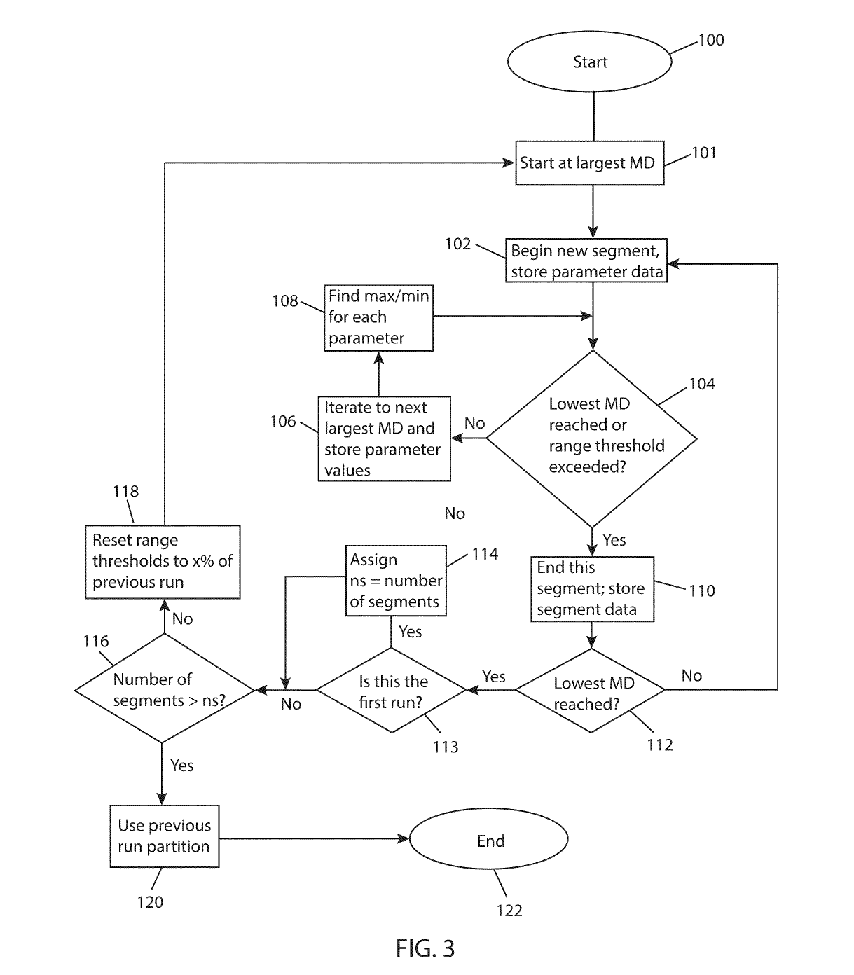

The computer program 10 provides (16) the well trajectory GRF data and range threshold values to a partitioning process 18. For the purposes of executing the partitioning process, let the well trajectory consist of np locations, indexed by i=0 . . . np-1. At each measured depth MD(i), the geomagnetic reference field is given by Btotal(i), Dip(i), and Dec(i), where i is an integer. The partitioning process now automatically divides the well trajectory into ns segments using, for example, the scheme shown in FIG. 3. (The procedure for partitioning a well trajectory section is the same as for partitioning an entire well trajectory. For partitioning a well trajectory section, only the well trajectory data related to the section is considered in the partitioning process.)

Well trajectories usually start with a vertical (low inclination) section and often end with a horizontal or high inclination section. Since the strength of the magnetic field increases with depth in most locations, it is usually necessary to divide the vertical portion of the well into multiple segments. A horizontal section, on the other hand, often does not have to be divided in order to fulfill the threshold criteria. It is therefore advisable to start the partitioning of the well trajectory at the end of the well (or of a well section) and work backward toward the well head. However, it should be noted that there is nothing wrong with starting the partitioning of the well trajectory at the beginning of the well (or of a well section) and working forward toward the end of the well (or of the well section).

Referring to FIG. 3, the partitioning process starts at 100. The process moves to 101 to search for the largest measured depth (MD) in the well trajectory GRF data (if the partitioning scheme is starting from the beginning of the well, the process would search for the lowest measured depth). The process then proceeds to 102 to begin partitioning of the well trajectory. The process starts with definition of the first segment. At 102, the GRF parameter data (Btotal, Dip, Dec) for the largest measured depth found in step 101 is stored (if the partitioning scheme is starting from the beginning of the well, the GRF parameter data for the lowest measured depth would be stored). At 104, the process checks whether the lowest measured depth has been reached (“condition 1”) or whether any of the parameters has exceeded the specified range threshold (“condition 2”). If neither condition 1 nor condition 2 is satisfied, the process iterates to the next largest measured depth in the well trajectory GRF data and stores the corresponding GRF parameter data, as shown at 106. Using the GRF parameter data stored so far for the current segment, the process finds the maximum and minimum values for each GRF parameter, as shown at 108, and then returns to check whether condition 1 or condition 2 is satisfied at 104. If condition 1 or condition 2 is not satisfied, the process repeats 106, 108, and 104. If condition 1 or condition 2 is satisfied, the partitioning of the current segment is complete. At the completion of the partitioning of the current segment, at 110, the segment data for the current is stored. The segment data may include, for example, the well trajectory locations corresponding to the endpoints of the segment and the maximum and minimum of each GRF parameter for the segment.

At 112, the process checks whether the lowest measured depth has been reached (“condition 3”). If condition 3 is not satisfied, the process begins the next segment partition by returning to 102. The process continues, as described above, until condition 3 is satisfied. At 113, the process checks whether the current run of the partitioning process is the first run of the partitioning process (“condition 4”). If condition 4 is satisfied, the parameter ns is set to the number of segments obtained from the current run of the partitioning process, as shown at 114.

The first partitioning of the well trajectory resulting from the first run of the partitioning process gives the minimum number of segments (ns) that are needed to keep the actual parameter ranges within each segment from exceeding the given range thresholds. However, one segment is likely to have a smaller measured depth range (along-hole distance) than the others and may be very short. Additional runs of the partitioning process with reduced range thresholds can be used to adjust the measured depth ranges (i.e., along-hole lengths) of the segments, as described below. It should be noted that repartitioning with reduced range thresholds, as will be described below, will not produce segments that will violate the initially specified range thresholds. That is, if variations in the GRF parameter values for the segments are within the reduced range thresholds, the variations would also be within the initially specified range thresholds that are higher than the reduced range thresholds.

At 116, the process checks whether the number of segments obtained from the previous run of the partitioning scheme exceeds ns (“condition 5”). (If the partition process has been run only once, then condition 5 will not be satisfied since the previous run will be the first run.) If condition 5 is not satisfied, the process moves to 118, where new range thresholds are determined as a percentage of the range thresholds in the previous run. The new range thresholds may be 99% of the previous range thresholds, for example. After computing the new reduced range thresholds, the well trajectory is repartitioned (101 to 112) with the reduced range thresholds. The process checks whether the current run is the first run at 113. If not, the process returns to 116. At 116, if condition 5 is not satisfied, the process returns to 118, where new (reduced) range thresholds are determined, as described above, followed by repartitioning the well trajectory (101 to 112). If condition 5 is satisfied, the partitioning from the previous run is used as the final partitioning, as shown at 120. The partitioning process then ends at 122. (At step 118, there is leeway in selecting how much to reduce the range thresholds for each new run of the partitioning process. For example, the reduction could be in a range from 90 to 99% of the previous range thresholds. In general, the reduction should be gradual so that the partitioning process does not end prematurely.)

As shown in FIG. 2A, the partitioning process returns the segment data (20) corresponding to the final partitioning to the computer program 10. As a final step, the computer program 10 computes representative values for Btotal, Dip, and Dec (the GRF parameters) for each segment identified in the segment data. This can be achieved, for example, by computing averages or median values for each GRF parameter for each segment. The computer program 10 associates the representative GRF values with the appropriate segments (“partitioning data”) and outputs or stores (22) the partitioning data for use in another application, such as in geosteering a well. It should be noted that this computation of representative GRF values may also be made in the partitioning process of FIG. 3, e.g., after step 120. The partitioning data may be stored with the description of the well trajectory initially received by the computer program 10.

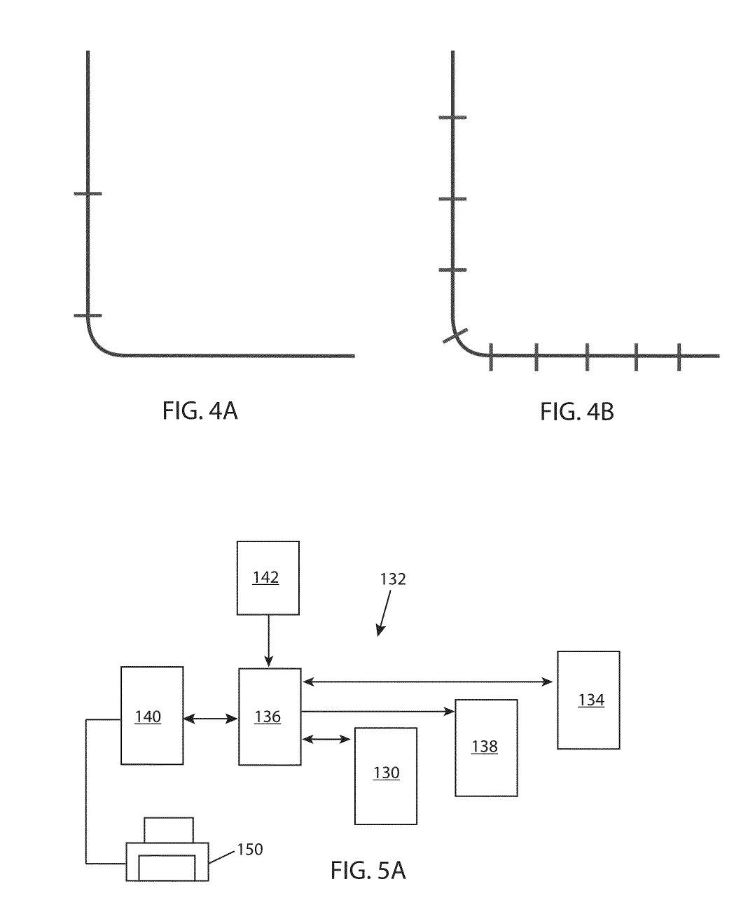

Examples of partitioning are given in FIGS. 4A and 4B for two well trajectories. FIG. 4A shows partitioning in an area with small magnetic field gradients. FIG. 4B shows partitioning in an area with large gradients. In the case shown in FIG. 4A, only 3 segments are needed in order to fulfill the threshold requirements for the ranges of Btotal, Dip, and Dec. In the case shown in FIG. 4B, the well trajectory has to be divided into a larger number of smaller segments in order to keep the parameter ranges within the prescribed range thresholds.

The foregoing process as explained with reference to FIGS. 2 and 3 can be embodied in computer-readable code (or instructions). Referring to FIG. 5A, the code can be stored in a memory 130 of a computer system 132 or a computer-readable medium 134, such as floppy disk, CD-ROM, or magnetic (or other type) hard drive, that is accessible to the computer system 132. The code will include the computer program (10 in FIG. 2A), the geomagnetic reference field model (14 in FIG. 2A), and logic for the partitioning process (18 in FIG. 2A). The computer system 132 includes a processor (or CPU) 136 and may further include an electronic display 138, such as a LCD display and the like, a communications interface (or communication port(s)) 140, such as USB ports, wireless connection ports and the like, and an input interface (or input device(s)) 142, such as a keyboard, mouse, and the like. According to this aspect, the computer-readable medium includes logic operable to cause the processor 136 to execute acts set forth above and explained with respect to the previous figures. For example, the processor 136 will execute the code stored in the computer-readable medium in order to generate the partitioning data (i.e., segment data and associated representative GRF values). FIG. 5B shows the display 138 with an example of windows that may be displayed as part of executing the code. The window 144 allows input of the well trajectory description as well as an output file name for the partitioning data, and the window 146 allows input of the range thresholds. Returning to FIG. 5A, the partitioning data can be stored in the computer-readable medium 134 and/or can be shown on the display 138. Displaying the partitioning data may also be by printing the partitioning data on a well plan using a printer 150, such as a laser printer, inkjet printer, and the like, that is linked to the computer system 132.

The method of assigning geomagnetic reference field values to a well trajectory described above can be applied to an entire well. Alternatively, the well can be divided into sections and the method can be applied to each section. This alternate method is useful when the sections are drilled some time apart. Since the geomagnetic field is changing over time, these sections may require different geomagnetic reference field values. By applying the method section by section, each section may have up-to-date geomagnetic reference field values at the beginning of drilling the section.

The method described above may be used to optimally partition a well trajectory into segments for other relevant parameters. Examples of such parameters are the reference value Gtotal for the total gravity acceleration or Field Acceptance (Quality Control) Criteria for MWD measurements.

In the method described above, the basis for partitioning the well trajectory is not limited to a magnetic model. Any Geomodel may be used as the basis for partitioning the well trajectory. A 3D gravity model is an example of a Geomodel that can be used besides a 3D geomagnetic reference field model. The geophysical reference parameters used in the partitioning of the well trajectory are selected based on the Geomodel to be interrogated for the geophysical reference values. For a 3D geomagnetic model, geomagnetic reference field parameters, such as Btotal, dip, and declination, are selected. For a gravity model, a gravity reference field parameter such as gravity acceleration is selected.

A practical application of the partitioning data obtained by the method described above is in drilling a well, or generally in navigating a well towards a target (this is also known as geosteering). In one practical example, a drill string is suspended in a well. A bottom hole assembly (BHA) and a drill bit are appended to the end of the drill string. The BHA includes a MWD tool and a rotary steerable directional drilling system. The BHA may further include a LWD tool and other tools known in the art. The MWD tool uses magnetometers to measure azimuth and accelerometers to measure inclination. The MWD tool may also (or alternately) use gyroscopes to measure azimuth. During drilling, the measurements made by the MWD tool (and LWD tool) are transmitted to the surface. For each segment of the well trajectory being drilled, the MWD data (and possibly the LWD data) together with the partitioning data for the segment are used to operate the steerable drilling system such that the drill string follows the well trajectory for that segment. This involves calculating inclination and azimuth angles using the geophysical reference values in the partitioning data for the segment.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of assigning geophysical reference values to a well trajectory, comprising:
defining a set of geophysical reference parameters;
assigning a range threshold to each geophysical reference parameter to be applied over a select measured depth range of the well trajectory;
processing a Geomodel to determine values of the geophysical reference parameters at a plurality of locations in the select measured depth range of the well trajectory;
partitioning the well trajectory in the select measured range into a plurality of segments such that variations in the values of the geophysical reference parameters within each segment do not exceed the respective range thresholds;
calculating a representative value of each geophysical reference parameter for each segment; and
at least one of displaying and storing the segments with the corresponding representative values of the geophysical reference parameters.

2. The method of claim 1, wherein the geophysical reference parameters are geomagnetic reference field parameters.

3. The method of claim 2, wherein the geomagnetic reference field parameters comprise total magnetic field, dip and declination.

4. The method of claim 2, wherein the Geomodel is a three-dimensional geomagnetic reference field model.

5. The method of claim 1, further comprising adjusting measured depth ranges of the segments prior to calculating the representative values of the geophysical reference parameters and at least one of storing and displaying the segments.

6. The method of claim 5, wherein the adjusting comprises:
reducing the range threshold for each geophysical reference parameter;
repartitioning the well trajectory in the select measured range into a plurality of segments such that variations in the values of the geophysical reference parameters within each segment do not exceed the reduced range thresholds; and
replacing the segments obtained from the partitioning with the segments obtained from the repartitioning if the number of segments obtained from the repartitioning does not exceed the number of segments obtained from the partitioning.

7. The method of claim 6, further comprising repeating the reducing, repartitioning, and replacing until the number of segments obtained from the repartitioning exceeds the number of segments obtained from the partitioning.

8. The method of claim 1, further comprising receiving a description of the well trajectory, wherein the description comprises information about the plurality of locations as a function of measured depth, true vertical depth, easting, and northing.

9. The method of claim 1, wherein the segments and representative values of the geophysical reference parameters are stored with a description of the well trajectory.

10. The method of claim 1, wherein the select measured depth range corresponds to an entire measured depth range of the well trajectory.

11. The method of claim 1, wherein the select measured depth range corresponds to a fraction of the entire measured depth range of the well trajectory.

12. The method of claim 11, further comprising repeating the assigning, processing, partitioning, calculating, and storing for another select measured depth range of the well trajectory that is different from the previous select measured depth range.

13. A non-transitory computer-readable medium having stored thereon a computer program for assigning geophysical reference values to a well trajectory, the computer program comprising a routine of set instructions for causing a computer to perform the steps of:
receiving a description of the well trajectory;
receiving a range threshold for each of a set of geophysical reference parameters to be applied over a select measured depth range of the well trajectory;
processing a Geomodel to determine values of the geophysical reference parameters at a plurality of locations contained in the description of the well trajectory;
partitioning the well trajectory in the select measured range into a plurality of segments such that variations in the values of the geophysical reference parameters within each segment do not exceed the respective range thresholds;
calculating a representative value of each geophysical reference parameter for each segment; and
at least one of storing and displaying the segments with the corresponding representative values of the geophysical reference parameters.

14. The non-transitory computer-readable medium of claim 13, wherein the computer program stored thereon further causes the computer to perform the step of adjusting measured depth ranges of the segments prior to calculating the representative values of the geophysical reference parameters and at least one of storing and displaying the segments.

15. The non-transitory computer-readable medium of claim 13, wherein the computer program stored thereon further causes the computer to perform the steps of:
reducing the range threshold for each geophysical reference parameter;
repartitioning the well trajectory into a plurality of segments such that variations in the values of the geophysical reference parameters within each segment do not exceed the reduced range thresholds; and
replacing the segments obtained from the partitioning with the segments obtained from the repartitioning if the number of segments obtained from the repartitioning does not exceed the number of segments obtained from the partitioning.

16. The non-transitory computer-readable medium of claim 13, wherein the computer program stored thereon further causes the computer to repeat the steps of reducing, repartitioning, and replacing until the segments obtained from the repartitioning exceeds the number of segments obtained from the partitioning.

17. The non-transitory computer-readable medium of claim 13, wherein the geophysical reference parameters are geomagnetic reference field parameters and the Geomodel is a three-dimensional geomagnetic reference model.
